(19) United States
(12) Patent Application Publication
(10) Pub. No.: US 2025/0209252 A1
(43) Pub. Date: Jun. 26, 2025

(54) METHOD, APPARATUS, ELECTRONIC DEVICE AND STORAGE MEDIUM FOR GENERATING PRESENTATION FILE

(71) Applicant: Beijing Zitiao Network Technology Co., Ltd., Beijing (CN)

(72) Inventors: Xiang ZHANG, Beijing (CN); Xiaojun KANG, Beijing (CN); Qing ZENG, Beijing (CN); Xiapu YANG, Beijing (CN); Qiyun ZHOU, Beijing (CN)

(21) Appl. No.: 18/983,168

(22) Filed: Dec. 16, 2024

(30) Foreign Application Priority Data
Dec. 22, 2023 (CN) 202311786930.X

(51) Int. Cl. G06F 40/103; G06F 40/205; G06F 40/253

(52) U.S. Cl. CPC G06F 40/103; G06F 40/205; G06F 40/253

(57) ABSTRACT

The present application provides a method, an apparatus, an electronic device, and a storage medium for generating presentation file. When a creation instruction for a presentation file from a user is received, target attribute information in the creation instruction is determined. The target attribute information can indicate a use requirement of the user because it is determined according to the creation instruction from the user. Then, target index data corresponding to the target attribute information is retrieved from a pre-constructed material database. A corresponding target material file obtained based on the target index data can better match the use requirement of the user. Therefore, a target presentation file that satisfies the use requirement of the user can be constructed based on the target material file, thereby ensuring the use experience of the user.

### CROSS REFERENCE TO RELATED APPLICATION(S)

This application claims priority of Chinese Patent Application No. 202311786930.X, filed on Dec. 22, 2023, entitled ‘Method, Apparatus, Electronic Device and Storage Medium for Generating Presentation File’ the disclosure of which is incorporated herein by reference in its entirety.

### FIELD

The present application relates to the field of data processing technologies, and in particular, to methods, apparatuses, electronic devices and storage media for generating a presentation file.

### BACKGROUND

A presentation file may present presentation content more dynamically and intuitively in a manner of combining text with media such as an image, a video, and audio.

However, a presentation file generated by a method for generating a presentation file in the prior art usually contains generalized content, which cannot meet the use requirement of a user, and affects the user experience.

### SUMMARY

In view of the above, an objective of the present application is to provide methods, apparatuses, electronic devices and a storage media for generating a presentation file, to solve or partially solve the above technical problems.

Based on the above objective, a first aspect of the present application provides a method for generating presentation file, comprising:
in response to receiving a creation instruction for a presentation file from a user, determining target attribute information in the creation instruction;
retrieving target index data corresponding to the target attribute information from a pre-constructed material database, and obtaining a target material file corresponding to the target index data, wherein the material database comprises index data of material files corresponding to different attribute information; and generating a target presentation file based on the target material file.

Based on the same inventive concept, a second aspect of the present application provides an apparatus for generating presentation file, comprising:
a determining module configured to, in response to receiving a creation instruction for a presentation file from a user, determine target attribute information in the creation instruction;
a retrieval module configured to retrieve target index data corresponding to the target attribute information from a pre-constructed material database, and obtaining a target material file corresponding to the target index data, wherein the material database comprises index data of material files corresponding to different attribute information; and
a generation module configured to generate a target presentation file based on the target material file.

Based on the same inventive concept, a third aspect of the present application provides an electronic device, comprising a memory, a processor, and a computer program stored on the memory and executable on the processor, wherein the program, when executed by the processor, implements the method according to the first aspect.

Based on the same inventive concept, a fourth aspect of the present application provides a non-transitory computer-readable storage medium storing computer instructions, wherein the computer instructions are used to cause a computer to perform the method according to the first aspect.

It can be seen from the above that in the method, apparatus, the electronic device and the storage medium for generating presentation file provided in the present application, when a creation instruction for a presentation file from a user is received, target attribute information in the creation instruction is determined. The target attribute information can indicate a use requirement of the user because the target attribute information is determined according to the creation instruction from the user. Then, target index data corresponding to the target attribute information is retrieved from a pre-constructed material database. A corresponding target material file obtained according to the target index data can better match the use requirement of the user. Therefore, a target presentation file that satisfies the use requirement of the user may be constructed based on the target material file, thereby ensuring the use experience of the user.

### BRIEF DESCRIPTION OF THE DRAWINGS

In order to more clearly describe the technical solutions in the present application or the related art, the following briefly describes the accompanying drawings used for describing the embodiments or the related art. It is obvious that the accompanying drawings in the following description merely show some embodiments of the present application, and a person of ordinary skill in the art can still derive other drawings from these accompanying drawings without creative efforts.

FIG. 1 is a schematic diagram of an application scenario according to an embodiment of the present application;

FIG. 2 is a flowchart of a method for generating presentation file according to an embodiment of the present application;

FIG. 3 is a schematic diagram of a structure of an apparatus for generating presentation file according to an embodiment of the present application; and

FIG. 4 is a schematic diagram of an electronic device according to an embodiment of the present application.

### DETAILED DESCRIPTION

It should be understood that data (including but not limited to data itself, data acquisition, or data use) involved in the technical solutions of the present application shall comply with requirements of applicable laws, regulations, and relevant provisions.

The principles and spirit of the present application will be described below with reference to several exemplary implementations. It should be understood that these implementations are merely provided for those skilled in the art to better understand and then implement the present application, instead of limiting the scope of the present application in any way. On the contrary, these implementations are provided to make the present application more thorough and complete, and to fully convey the scope of the present application to those skilled in the art.

It should be understood that before the technical solutions of the embodiments of the present application are used, the user is notified of the type, scope of use, and use scenario of personal information involved and the user's authorization is obtained through an appropriate manner.

For example, in response to receiving an active request from a user, a prompt message is sent to the user to clearly prompt the user that the operation requested by the user will need to acquire and use the user's personal information. In this way, the user may choose whether to provide personal information to the software or hardware, such as an electronic device, an application, a server, or a storage medium, that executes an operation of the technical solution of the present application based on the prompt message.

As an optional but non-restrictive implementation, the manner of sending the prompt message to the user in response to receiving the active request from the user may be, for example, in the form of a pop-up window, and the prompt message may be presented in the pop-up window in text. In addition, the pop-up window may further carry a select control for the user to select “agree” or “disagree” to provide personal information to the electronic device.

It should be understood that the above process of notifying and obtaining the user authorization is merely schematic and does not limit the implementation of the present application. Other manners that comply with relevant laws and regulations may also be applied to the implementation of the present application.

In the present application, it should be understood that any quantity of elements in the accompanying drawings is for example rather than limitation, and any naming is merely for distinction, without any limiting meaning.

The principles and spirit of the present application are described below in detail with reference to several representative implementations of the present application.

FIG. 1 is a schematic diagram of an application scenario of a method for presenting presentation file according to an embodiment of the present application. The application scenario includes a terminal device 101, a server 102, and a data storage system 103. The terminal device 101, the server 102, and the data storage system 103 may be connected through a wired or wireless communication network. The terminal device 101 includes but is not limited to a desktop computer, a mobile phone, a mobile computer, a tablet computer, a media player, a smart wearable device, a personal digital assistant (PDA), or another electronic device that can implement the foregoing functions. The server 102 and the data storage system 103 may each be an independent physical server, or may be a server cluster or distributed system including a plurality of physical servers, or may be a cloud server that provides basic cloud computing services such as cloud service, cloud database, cloud computing, cloud function, cloud storage, network service, cloud communication, middleware service, domain name service, security service, content delivery network (CDN), big data, and artificial intelligence platform.

A user interacts with the terminal device 101 to generate a creation instruction for a presentation file, and then the terminal device 101 sends the creation instruction to the server 102. The server 102 determines target attribute information in the creation instruction, and then the server 102 retrieves target index data corresponding to the target attribute information from a pre-constructed material database, and obtains a target material file corresponding to the target index data, and generates a target presentation file based on the target material file, and then sends the target presentation file via the server 102 to the terminal device 101 for display. The data storage system 103 provides data storage support for the operation of the server 102, for example, for storing related data of operation program code and data screening results.

The method for generating presentation file according to an exemplary implementation of the present application is described below with reference to the application scenario in FIG. 1. It should be noted that the foregoing application scenario is merely shown to facilitate understanding the spirit and principle of the present application, and the implementation of the present application is not limited in this respect. In contrast, the implementation of the present application may be applied to any applicable scenario.

An embodiment of the present application provides a method for generating presentation file.

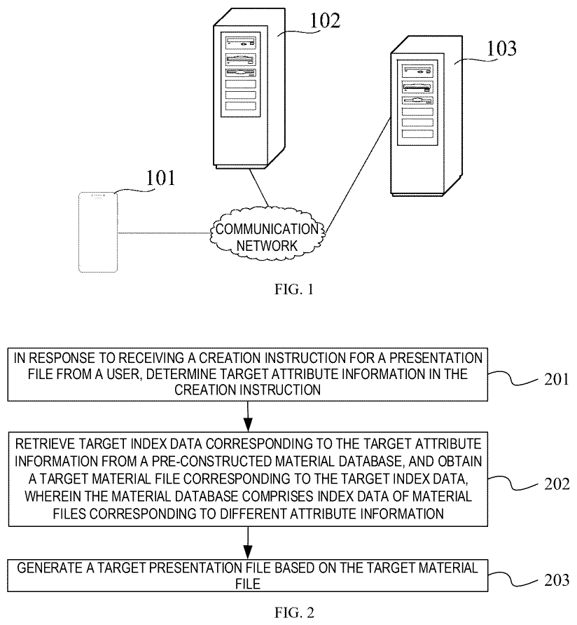

As shown in FIG. 2, the method comprises:

Step 201: in response to receiving a creation instruction for a presentation file from a user, determining target attribute information in the creation instruction.

In some embodiments, the creation instruction may be a voice creation instruction, a trigger instruction for a creation control, or a text input creation instruction. The creation instruction may be voice or text sent through an instant messaging session window. For example, the user inputs voice or text in a message input area of the session window, and the voice or text sent is the creation instruction received in step 201. The session window may be a session window with a robot or a session window with another user. In the session window with another user, the robot may be invoked, and the creation instruction is sent.

The target attribute information is used to indicate a use requirement of the user.

The presentation file may be a file in a PPT (PowerPoint presentation) format or a file in a PPTX (PowerPoint presentation) format.

Alternatively, the presentation file may be an online document that can be viewed and edited on various terminals (applications, browsers, etc.) through cloud storage and supports multi-simultaneous collaborative editing.

When the creation instruction for the presentation file from the user is received, the target attribute information is determined based on the creation instruction, so that the target attribute information can represent the use requirement of the user.

For example, the user gives a voice creation instruction for a presentation file to an instant messaging application or a web page: “Generate a presentation file for a customer in X industry based on material library A, focusing on introducing function β, and the audience is m”, to determine target attribute information in the creation instruction.

In some embodiments, in step 201, determining target attribute information in a creation instruction comprises:
step A1: parsing a field value corresponding to a predetermined key field in the creation instruction, and determining the target attribute information.

In some embodiments, parsing training is performed in advance by using a neural network, to obtain a neural network model that can perform parsing. Then the neural network model is used to parse the creation instruction, parse the field value corresponding to the predetermined key field in the creation instruction, and determine the target attribute information.

The neural network model can ensure that the determined target attribute information is more accurate, and further can ensure that a subsequently generated target presentation file can better meet the use requirement of the user.

In some embodiments, the predetermined key field comprises an application industry of a presentation file, a subject of the presentation file, and/or an audience of the presentation file; and the target attribute information comprises a target application industry, a target subject, and/or a target audience.

Step A1 comprises:
step A11: parsing, from the creation instruction, a field value corresponding to the application industry of the presentation file, the subject of the presentation file, and/or the audience of the presentation file, and obtaining the target application industry, the target subject, and/or the target audience; and
step A12: determining the target attribute information based on the target application industry, the target subject, and/or the target audience.

In some embodiments, the field value corresponding to the application industry of the presentation file, the subject of the presentation file, and/or the audience of the presentation file is parsed from the creation instruction, to determine the target application industry, the target subject, and/or the target audience to which the target presentation file that the user needs to use belongs. It can be further ensured that the subsequently generated target presentation file can better satisfy the use requirement of the user, and can satisfy use scenarios to which the user needs to apply.

For example, the user gives a voice creation instruction for a presentation file to an instant messaging application or a web page: “Generate a presentation file for a customer in X industry, focusing on introducing function β, and the audience is m”. Field values corresponding to an application industry of the presentation file, a subject of the presentation file, and an audience of the presentation file are parsed from the creation instruction. A field value corresponding to the application industry of the presentation file that is parsed from the creation instruction is a target application industry “X industry”, a field value corresponding to the subject of the presentation file is a target subject “function β”, and a field value corresponding to the audience of the presentation file is a target audience “m”.

The target application industry “X industry”, the target subject “function β”, and the target audience “m” are used as the target attribute information.

In addition, if a material library name specified by the user is not parsed from the creation instruction, a prestored default material library is selected.

Step 202: retrieving the target index data corresponding to the target attribute information from the pre-constructed material database, and obtaining a target material file corresponding to the target index data, wherein the material database comprises index data of material files corresponding to different attribute information.

In some embodiments, the index data is used to indicate a location of the target material file.

Because the material database stores the index data of the material files corresponding to the different attribute information, the target index data corresponding to the target attribute information can be found from the pre-constructed material database. A structure of the target index data is “a location of an original file where a target material is located—an identification of a specific page number of the original file where the target material file is located”. Therefore, the target material file can be obtained based on the specific page number identification. The manner of obtaining the target material file based on the specific page number identification can ensure accuracy of the obtained target material file.

For example, the target attribute information comprises a target application industry “X industry”, a target subject “function β”, and a target audience “m”. Therefore, target index data of a material file whose target application industry is “X industry”, whose target subject is “function β”, and whose target audience is “m” is retrieved from the material database. Because the target index data contains the identification of the specific page number of the original file where the target material file is located, the target material file can be obtained based on the specific page number identification.

In some embodiments, the predetermined key field comprises a material library name; and the target attribute information comprises a target material library name.

In step 202, retrieving the target index data corresponding to the target attribute information from the pre-constructed material database comprises:
step B1: determining a target material database based on the target material library name; and
step B2: retrieving the target index data corresponding to the target attribute information from the target material database.

In some embodiments, a field value corresponding to the material library name, that is, the target material library name, is parsed from the creation instruction, and the target material library name is used as the target attribute information.

For example, the target material library name is A. Therefore, a location of a target material database is retrieved based on the target material library name A, the target material database is fetched based on the location of the target material database, and then the target index data corresponding to the target attribute information is retrieved from the target material database.

Wherein, the target material database may be a database table, an electronic table, or an online electronic table.

If the material library name specified by the user is not parsed from the creation instruction, a prestored default material library is selected.

In addition, the target material database may also be determined based on a link of the target material library.

In some embodiments, after step 202, the method further comprises:
step C1: obtaining a template generation rule; and
step C2: sorting the target material files according to the template generation rule.

In some embodiments, the target material file may be of a type such as a cover, a culture introduction, the performance management, a sign (LOGO) wall, or a back cover etc.

The template generation rule is used to represent an assembly and arrangement sequence of the target material files of different types in the target presentation file, which may be set according to a specific situation. The template generation rule is not specifically limited here.

The target material files are sorted and combined based on the template generation rule. For example, the obtained target material files are of types such as a cover, a culture introduction, the performance management, a sign (LOGO) wall, and a back cover, and the corresponding target material files are sorted based on an arrangement sequence of: the cover, the culture introduction, the performance management, the sign (LOGO) wall, and the back cover.

In some embodiments, in step 202, obtaining the target material file corresponding to the target index data comprises:
step D1: fetching the target material file based on the target index data;
step D2: retrieving a target historical application material file corresponding to the target attribute information from a predetermined historical application material database, wherein the historical application material database comprises historical application material files of material files corresponding to different attribute information; and
step D3: adding the target historical application material file to the target material files, wherein the target historical application material file comprises at least one of the following:

text, a picture, and a video.

In some embodiments, the historical application material database represents a material database that is historically used by the user.

The target historical application material file corresponding to the target attribute information is retrieved from the historical application material database and added to the target material file, to combine with the target material file and assemble a page of the target presentation file. Thereby, content of the target presentation file is richer. In addition to being adaptable to a use scenario to which the user needs to apply, the user experience can also be improved.

In addition, the page of the target presentation file may also be assembled by separately combining the target historical application material files.

Step 203: generating a target presentation file based on the target material file.

In some embodiments, the target presentation file represents a presentation file generated for the user.

The target material files are directly combined to generate the target presentation file, or the target material files are combined and inserted to generate the target presentation file.

Alternatively, the sorted target material files may be combined and inserted to generate the target presentation file.

Compared with manual selection of materials for the presentation file by the user, the present application is more time-efficient and labor-efficient, and does not require the user to be familiar with content of the material database.

In some embodiments, step 203 comprises:

step 2031: creating a presentation file; and

step 2032: displaying the target material file in the presentation file to generate the target presentation file.

In some embodiments, the new presentation file is created, and the target material files are inserted into the presentation file one by one, to generate the target presentation file.

Alternatively, the sorted target material files are inserted into the presentation file one by one, to generate the target presentation file.

Compared with manual selection of materials for the presentation file by the user, the present application is more time-efficient and labor-efficient, and does not require the user to be familiar with content of the material database.

In some embodiments, after step 2032, the method further comprises:

step E1: generating and displaying a link corresponding to the target presentation file.

In some embodiments, after the target presentation file is generated, a link of the target presentation file is generated and displayed, for the user to access, view, and use.

In some embodiments, after the target presentation file is generated, a target message is generated in an instant messaging session window, and the link of the target presentation file is displayed through the message, that is, the message contains the link.

In some embodiments, after the target presentation file is generated, a target message is generated in an instant messaging session window, and the message contains information of the target material file, for example, specific page number information or link address information of the target material file in the material library. In some embodiments, after step E1, the method further comprises:

in response to receiving a style adjustment instruction for the target presentation file from a user, adjusting a style of the target presentation file corresponding to the link.

In some embodiments, the style adjustment instruction may be a touch instruction of a style adjustment control, a voice instruction for style adjustment, or a text input instruction for style adjustment.

When the style adjustment instruction for the target presentation file from the user is received, the style of the target presentation file corresponding to the link may be adjusted based on a style adjustment manner corresponding to the style adjustment instruction, to implement one-click beautification and optimization of the style of the target presentation file, without the need for manual and repeated adjustment, so that the target presentation file is more beautiful and the user experience is further improved.

In some embodiments, a construction process of the material database comprises:
step F1: obtaining index data corresponding to respective material files and attribute information corresponding to the respective material files.
step F2: associating the index data corresponding to the respective material files with the attribute information corresponding to the respective material files to generate the material database.

In some embodiments, the material database needs to be organized and constructed in a specific manner. The index data corresponding to respective material files and the attribute information corresponding to respective material files are obtained. Then the index data is associated with the attribute information, to generate the material database.

For example, a right-click menu item is added to a thumbnail of each material file in a navigation bar, and links corresponding to respective material files are copied in the displayed menu items. The link contains the index data corresponding to respective material files. The attribute information corresponding to respective material files comprises an industry, an audience, a subject, a style, and the like.

Then labeling is performed on the index data and the corresponding attribute information of each material file. The labeling manner is to associate the index data corresponding to each material file with the corresponding attribute information, to generate the material database.

Wherein, the attribute information may be changed.

Through the foregoing solution, when a creation instruction for a presentation file from a user is received, target attribute information in the creation instruction is determined. The target attribute information can indicate a use requirement of the user because it is determined according to the creation instruction from the user. Then, target index data corresponding to the target attribute information is retrieved from a pre-constructed material database. A corresponding target material file obtained based on the target index data can better match the use requirement of the user. Therefore, a target presentation file that satisfies the use requirement of the user can be constructed based on the target material file, thereby ensuring the user experience.

It should be noted that the method in the embodiments of the present application may be performed by a single device, for example, a computer or a server. The method in this embodiment may also be applied to a distributed scenario, and is completed by a plurality of devices working together. In this distributed scenario, one of the plurality of devices may only perform one or more steps of the method in the embodiments of the present application, and the plurality of devices will interact with each other to complete the method.

It should be noted that some embodiments of the present application are described above. Other embodiments are within the scope of the appended claims. In some cases, actions or steps recited in the claims may be performed in an order different from that in the embodiments described above and still achieve the desired results. In addition, the processes depicted in the accompanying drawings do not necessarily require the specific order or the consecutive order shown to achieve the desired results. In some implementations, multitasking and parallel processing are also possible or may be advantageous.

Based on the same inventive concept, corresponding to the method in any of the foregoing embodiments, the present application further provides an apparatus for generating presentation file.

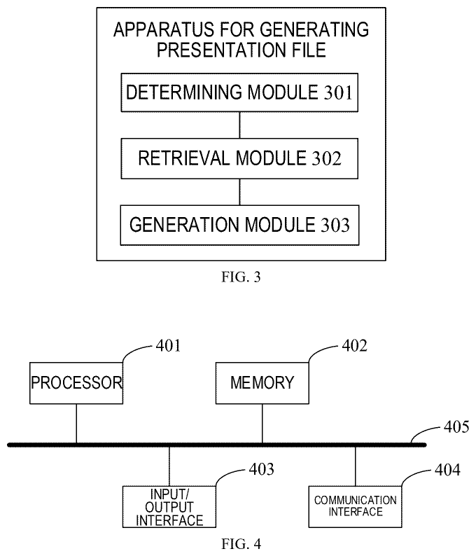

As shown in FIG. 3, the apparatus for generating presentation file comprises:
a determining module 301 configured to, in response to receiving a creation instruction for a presentation file from a user, determine target attribute information in the creation instruction;
a retrieval module 302 configured to retrieve target index data corresponding to the target attribute information from a pre-constructed material database, and obtaining a target material file corresponding to the target index data, wherein the material database comprises index data of material files corresponding to different attribute information; and
a generation module 303 configured to generate a target presentation file based on the target material file.

In some embodiments, the determining module 301 comprises:
a parsing unit, configured to parse a field value corresponding to a predetermined key field in the creation instruction, and determine the target attribute information.

In some embodiments, the predetermined key field comprises a material library name; the target attribute information comprises a target material library name;
the retrieval module 302 is specifically configured to:
   determine a target material database based on the target material library name; and
   retrieve the target index data corresponding to the target attribute information from the target material database.

In some embodiments, the predetermined key field comprises an application industry of a presentation file, a subject of the presentation file, and/or an audience of the presentation file; the target attribute information comprises a target application industry, a target subject, and/or a target audience; and
the parsing unit is specifically configured to:
   parse, from the creation instruction, a field value corresponding to the application industry of the presentation file, the subject of the presentation file, and/or the audience of the presentation file, and obtaining the target application industry, the target subject, and/or the target audience; and
   determine the target attribute information based on the target application industry, the target subject, and/or the target audience.

In some embodiments, the apparatus for generating presentation file further comprises a sorting module, and after obtaining the target material file corresponding to the target index data, the sorting module is specifically configured to:
obtain a template generation rule; and
sort the target material files according to the template generation rule.

In some embodiments, the generation module 303 is specifically configured to:
create a presentation file; and
display the target material file in the presentation file to generate the target presentation file.

In some embodiments, the apparatus for generating presentation file further comprises a link generation module, and after displaying the target material files in the presentation file, the link generation module is specifically configured to:
generate and display a link corresponding to the target presentation file.

In some embodiments, the apparatus for generating presentation file further comprises a style adjustment module, and after generating and displaying a link corresponding to the target presentation file, the style adjustment module is specifically configured to:
in response to receiving a style adjustment instruction for the target presentation file from a user, adjust a style of the target presentation file corresponding to the link.

In some embodiments, the apparatus for generating presentation file further comprises a database construction module, and the database construction module is specifically configured to:
obtain index data corresponding to respective material files and attribute information corresponding to the respective material files; and
associate the index data corresponding to the respective material files with the attribute information corresponding to the respective material files to generate the material database.

In some embodiments, the retrieval module 302 is specifically configured to:
fetch the target material file based on the target index data;
retrieve a target historical application material file corresponding to the target attribute information from a predetermined historical application material database, wherein the historical application material database comprises historical application material files of material files corresponding to different attribute information; and
add the target historical application material file to the target material files, wherein the target historical application material file comprises at least one of the following:
   text, a picture, and a video.

For ease of description, the above apparatus is described by dividing the functions into various modules. Certainly, when the present application is implemented, the functions of the modules may be implemented in one or more software and/or hardware.

The apparatus in the foregoing embodiment is configured to implement the corresponding method for generating presentation file in any of the foregoing embodiments, and has the beneficial effects of the corresponding method embodiment. Details are not described herein again.

Based on the same inventive concept, corresponding to the method in any of the foregoing embodiments, the present application further provides an electronic device, comprising a memory, a processor, and a computer program stored on the memory and executable on the processor, wherein the processor implements the method for generating presentation file according to any one of the foregoing embodiments when executing the program.

FIG. 4 shows a schematic diagram of a more specific hardware structure of an electronic device according to this embodiment. The device may include a processor 401, a memory 402, an input/output interface 403, a communication interface 404, and a bus 405. The processor 401, the memory 402, the input/output interface 403, and the communication interface 404 are connected to each other through the bus 405 to implement communication inside the device.

The processor 401 may be implemented in a manner of a general-purpose CPU (Central Processing Unit), a microprocessor, an ASIC (Application Specific Integrated Circuit), or one or more integrated circuits, and is configured to execute a related program to implement the technical solution provided in the embodiments of this specification.

The memory 402 may be implemented in a form of a ROM (Read Only Memory), a RAM (Random Access Memory), a static storage device, a dynamic storage device, or the like. The memory 402 may store an operating system and other application programs. When the technical solution provided in the embodiments of this specification is implemented through software or firmware, related program code is stored in the memory 402 and is invoked and executed by the processor 401.

The input/output interface 403 is configured to connect to an input/output module to implement information input and output. The input/output module may be configured in the device as a component (not shown in the figure), or may be externally connected to the device to provide a corresponding function. The input device may include a keyboard, a mouse, a touchscreen, a microphone, various sensors, and the like, and the output device may include a display, a speaker, a vibrator, an indicator light, and the like.

The communication interface 404 is configured to connect to a communication module (not shown in the figure), to implement communication and interaction between the device and another device. The communication module may implement communication in a wired manner (for example, USB or network cable) or in a wireless manner (for example, a mobile network, WIFI, or Bluetooth).

The bus 405 includes a path to transfer information between respective components (for example, the processor 401, the memory 402, the input/output interface 403, and the communication interface 404) of the device.

It should be noted that although the foregoing device shows only the processor 401, the memory 402, the input/output interface 403, the communication interface 404, and the bus 405, in a specific implementation process, the device may further include other components necessary for normal operation. In addition, those skilled in the art may understand that the foregoing device may include only components necessary for implementing the solution of the embodiments of this specification, instead of all components shown in the figure.

The electronic device in the foregoing embodiment is configured to implement the corresponding method for generating presentation file in any of the foregoing embodiments, and has the beneficial effects of the corresponding method embodiment. Details are not described herein again.

Based on the same inventive concept, corresponding to the method in any of the foregoing embodiments, the present application further provides a non-transitory computer-readable storage medium storing computer instructions, wherein the computer instructions are used to cause the computer to execute the method for generating presentation file according to any one of the foregoing embodiments.

The computer-readable medium in this embodiment includes a permanent and non-permanent, and removable and non-removable medium, and information may be stored by any method or technology. The information may be computer-readable instructions, a data structure, a program module, or other data. Examples of the computer storage medium include, but are not limited to, a phase change memory (PRAM), a static random-access memory (SRAM), a dynamic random-access memory (DRAM), other types of random-access memories (RAM), a read-only memory (ROM), an electrically erasable programmable read-only memory (EEPROM), a flash memory, or other memory technologies, a compact disc read-only memory (CD-ROM), a digital versatile disc (DVD) or other optical storage, a magnetic cassette, a magnetic tape, a magnetic disk storage, or other magnetic storage devices, or any other non-transmission medium, which can be used to store information accessible to the computing device.

The computer instructions stored in the storage medium in the foregoing embodiment are used to cause the computer to execute the method for generating presentation file according to any one of the foregoing embodiments, and have the beneficial effects of the corresponding method embodiment. Details are not described herein again.

A person of ordinary skill in the art should understand that the discussions of any of the foregoing embodiments are merely exemplary, and are not intended to imply that the scope of the present application (including the claims) is limited to these examples; under the concept of the present application, the technical features in the foregoing embodiments or in different embodiments may also be combined, and the steps may be implemented in any order, and there are many other variations of different aspects of the embodiments of the present application as described above. For the sake of brevity, they are not provided in the details.

In addition, for simplicity of description and discussion, and in order not to make the embodiments of the present application difficult to understand, well-known power/ground connections to the integrated circuit (IC) chips and other components may or may not be shown in the provided drawings. Further, the apparatus may be shown in the form of a block diagram, in order to avoid making the embodiments of the present application difficult to understand, and this is also considered the fact that details of implementations of the block diagram apparatus are highly dependent on a platform on which the embodiments of the present application are to be implemented (that is, the details should be completely within the understanding scope of those skilled in the art). When specific details (for example, a circuit) are set forth to describe the exemplary embodiments of the present application, it will be apparent to those skilled in the art that the embodiments of the present application may be implemented without these specific details or with variations of these specific details. Therefore, these descriptions should be considered as illustrative and not restrictive.

Although the present application has been described in conjunction with specific embodiments of the present application, many alternatives, modifications, and variations of these embodiments will be apparent to those of ordinary skill in the art from the foregoing description. For example, other memory architectures (for example, a dynamic RAM (DRAM)) may use the embodiments discussed.

The embodiments of the present application are intended to cover all such alternatives, modifications, and variations that fall within the broad scope of the appended claims. Therefore, any omissions, modifications, equivalent replacements, improvements, etc. made within the spirit and principle of the embodiments of the present application shall be included within the protection scope of the present application.

I/We claim:

1. A method for generating presentation file, comprising:
in response to receiving a creation instruction for a presentation file from a user, determining target attribute information in the creation instruction;
retrieving target index data corresponding to the target attribute information from a pre-constructed material database, and obtaining a target material file corresponding to the target index data, wherein the material database comprises index data of material files corresponding to different attribute information; and
generating a target presentation file based on the target material file.

2. The method according to claim 1, wherein determining the target attribute information in the creation instruction comprises:
parsing a field value corresponding to a predetermined key field in the creation instruction, and determining the target attribute information.

3. The method according to claim 2, wherein the predetermined key field comprises a material library name;
the target attribute information comprises a target material library name;
retrieving the target index data corresponding to the target attribute information from the pre-constructed material database comprises:
determining a target material database based on the target material library name; and
retrieving the target index data corresponding to the target attribute information from the target material database.

4. The method according to claim 2, wherein the predetermined key field comprises an application industry of THE presentation file, a subject of the presentation file, and/or an audience of the presentation file; the target attribute information comprises a target application industry, a target subject, and/or a target audience;
parsing the field value corresponding to the predetermined key field in the creation instruction, and determining the target attribute information comprises:
parsing, from the creation instruction, a field value corresponding to the application industry of the presentation file, the subject of the presentation file, and/or the audience of the presentation file, and obtaining the target application industry, the target subject, and/or the target audience; and
determining the target attribute information based on the target application industry, the target subject, and/or the target audience.

5. The method according to claim 1, wherein after obtaining the target material file corresponding to the target index data, the method further comprises:
obtaining a template generation rule; and
sorting the target material files according to the template generation rule.

6. The method according to claim 1, wherein generating the target presentation file based on the target material file comprises:
creating a presentation file; and
displaying the target material file in the presentation file to generate the target presentation file.

7. The method according to claim 6, wherein after displaying the target material files in the presentation file, the method further comprises:
generating and displaying a link corresponding to the target presentation file.

8. The method according to claim 7, wherein after generating and displaying the link corresponding to the target presentation file, the method further comprises:
in response to receiving a style adjustment instruction for the target presentation file from the user, adjusting a style of the target presentation file corresponding to the link.

9. The method according to claim 1, wherein a process for constructing the material database comprises:
obtaining index data corresponding to respective material files and attribute information corresponding to the respective material files; and
associating the index data corresponding to the respective material files with the attribute information corresponding to the respective material files to generate the material database.

10. The method according to claim 1, wherein obtaining the target material file corresponding to the target index data comprises:
fetching the target material file based on the target index data;
retrieving a target historical application material file corresponding to the target attribute information from a predetermined historical application material database, wherein the historical application material database comprises historical application material files of material files corresponding to different attribute information; and
adding the target historical application material file to the target material files, wherein the target historical application material file comprises at least one of:
text, a picture, and a video.

11. An electronic device, comprising a memory, a processor, and a computer program stored on the memory and executable on the processor, wherein the program, when executed by the processor, implements a method for generating presentation file, comprising:
in response to receiving a creation instruction for a presentation file from a user, determining target attribute information in the creation instruction;
retrieving target index data corresponding to the target attribute information from a pre-constructed material database, and obtaining a target material file corresponding to the target index data, wherein the material database comprises index data of material files corresponding to different attribute information; and
generating a target presentation file based on the target material file.

12. The electronic device of claim 11, wherein determining the target attribute information in the creation instruction comprises:
parsing a field value corresponding to a predetermined key field in the creation instruction, and determining the target attribute information.

13. The electronic device of claim 12, wherein the predetermined key field comprises a material library name;
the target attribute information comprises a target material library name;
retrieving the target index data corresponding to the target attribute information from the pre-constructed material database comprises:
determining a target material database based on the target material library name; and
retrieving the target index data corresponding to the target attribute information from the target material database.

14. The electronic device of claim 12, wherein the predetermined key field comprises an application industry of a presentation file, a subject of the presentation file, and/or an audience of the presentation file; the target attribute information comprises a target application industry, a target subject, and/or a target audience;
parsing the field value corresponding to the predetermined key field in the creation instruction, and determining the target attribute information comprises:
parsing, from the creation instruction, a field value corresponding to the application industry of the presentation file, the subject of the presentation file, and/or the audience of the presentation file, and obtaining the target application industry, the target subject, and/or the target audience; and
determining the target attribute information based on the target application industry, the target subject, and/or the target audience.

15. The electronic device of claim 11, wherein after obtaining the target material file corresponding to the target index data, the method further comprises:
obtaining a template generation rule; and
sorting the target material files according to the template generation rule.

16. The electronic device of claim 11, wherein generating the target presentation file based on the target material file comprises:
creating a presentation file; and
displaying the target material file in the presentation file to generate the target presentation file.

17. The electronic device of claim 16, wherein after displaying the target material files in the presentation file, the method further comprises:
generating and displaying a link corresponding to the target presentation file.

18. The electronic device of claim 17, wherein after generating and displaying the link corresponding to the target presentation file, the method further comprises:
in response to receiving a style adjustment instruction for the target presentation file from a user, adjusting a style of the target presentation file corresponding to the link.

19. The electronic device of claim 11, wherein a process for constructing the material database comprises:
obtaining index data corresponding to respective material files and attribute information corresponding to the respective material files; and
associating the index data corresponding to the respective material files with the attribute information corresponding to the respective material files to generate the material database.

20. A non-transitory computer-readable storage medium storing computer instructions, wherein the computer instructions are used to cause a computer to perform a method for generating presentation file, comprising:
in response to receiving a creation instruction for a presentation file from a user, determining target attribute information in the creation instruction;
retrieving target index data corresponding to the target attribute information from a pre-constructed material database, and obtaining a target material file corresponding to the target index data, wherein the material database comprises index data of material files corresponding to different attribute information; and
generating a target presentation file based on the target material file.
